(19) United States
(12) Patent Application Publication
(10) Pub. No.: US 2011/0138305 A1
(43) Pub. Date: Jun. 9, 2011

(54) Method and system for random matching and real-time compatibility assessment to facilitate serendipitous dating

(76) Inventors: Yoshiko Akai, New York, NY (US); Radoslav P. Kotorov, Somerset, NJ (US); Scott David Hathaway, Brooklyn, NY (US)

(21) Appl. No.: 12/925,968

(22) Filed: Nov. 3, 2010

Related U.S. Application Data
(60) Provisional application No. 61/283,357, filed on Dec. 3, 2009.

(51) Int. Cl. G06F 3/01; G06F 15/16

(52) U.S. Cl. 715/753

(57) ABSTRACT

A method and system for random matching of two individuals from within computer generated virtual pools of individuals with means for rapid, real-time, interactive assessment of their mutual compatibility on mobile and computer devices. Participating individuals indicate via device interfaces their availability for matching and the system determines and registers their locations. Participating individuals place requests for matching and the system algorithmically constructs proximity based virtual matching pools. For each matching request, an individual is selected randomly from the virtual matching pool and the two matched individuals are placed in a real-time, synchronous, compatibility assessment session. The system presents the matched individuals with a sequence of questions, tabulates the individual responses, calculates a matching score, and displays the matching score simultaneously to both participants in the compatibility assessment session. If the structured compatibility assessment session indicates a high degree of compatibility, the system facilitates a meeting between the matched individuals.

### FIELD OF THE INVENTION

This invention relates to techniques for electronic dating and matching services, more particularly, in addition to the prior art it provides ability to identify participants within given geographic proximity in real time and a system to match and connect individuals in a synchronous session for assessing their mutual compatibility.

### BACKGROUND OF THE INVENTION

Online dating and searching for companionship is becoming increasingly popular due to significant life style changes. A growing segment of society has become extremely mobile, always connected to the web via mobile and computer devices, and with less time for conventional social relationships. The lack of time for in-person mingling has contributed to the development of online means for socializing and maintaining relationships.

Social settings and in-person meetings are very important as they provide chance for serendipitous encounters. While all online dating services deploy matching processes that save time to their users in finding potential matches, they also inadvertently leave out serendipity and other elements of pleasant surprise that lead to instantaneous bonding. Many successfully matched couples emphasize the role of chance and “aha” moments that made them aware of the potentially strong compatibility between them.

There are two types of online matching processes: (1) algorithmic matching and (2) profile search. Most sites also offer free-form instant messaging to initialize direct contact after the initial matching. Algorithmic matching uses mathematical methods to determine which personal attributes matter in the matching process and estimate their relative importance. The inherent weakness of this method is that the estimates are based on historical information provided by other users. Beauty is in the eye of the beholder and so are the personal attributes that make one individual attractive to another. Sometimes similarities attract people to one another and other times opposites attract them. At the present moment, there is no proven scientific way of determining the causes of attraction.

Profile search relies on the individual user to research and evaluate online profiles of other users for potential matches. While this approach recognizes that “beauty is in the eye of the beholder” it has other disadvantages. First, it is difficult for people to form opinions about the other individuals based solely on structured profile attributes, such as height, weight, occupation, age, hobbies, etc. Algorithmic matching emerged because people are not good at assigning weights to attributes, and, thus, any subjective decision based on a list of attributes is likely to be inaccurate and biased. Second, supplemental free text descriptions, bios, or story lines may facilitate the evaluation as they are more personal than lists of attributes, but they also introduce an element of creative writing, which is a skill that not all users possess. Plain descriptions may not convey important personality traits well, while skillfully written descriptions may be misleading. The profile evaluation process requires users to consider too many possibilities and obstacles, and as some psychologists point out, if a person has to weigh more than three requirements, he or she may never find that perfect match. Serendipity matters because the “Aha” moment helps people overcome the desire to question apprehensively every personal attribute in the potential match. Text descriptions have another disadvantage: they are time consuming to read and evaluate. Hence, most users read only a few profiles which are selected based on limited and often misleading information such as pictures, titles, or one line introductions.

Most online dating sites allow users to initiate instant messaging or email exchange in order to augment the algorithmic and profile search process via direct personal communication. While personal conversations in social settings generally help individuals to assess the level of mutual attraction, the free-form online exchange may have the opposite effect and deter people from setting an in-person meeting. Online conversations do not provide the participants with the visual and emotional clues that lead to the “Aha” moment in social settings, and there is nothing in the current art to supplement for this deficiency.

Mobility and mobile devices are driving another important life style change. Many traveling people today are inclined to use mobile and electronic devices to seek spontaneous contacts with strangers within certain proximity. This behavior is analogous to the socialization with strangers that occurs frequently in hotel lobbies, bars, and restaurants. Online socialization significantly widens the pool of people and offers means to pre-screen potential contacts. Yet, to be effective, online socialization has to provide not only means to connect to strangers within certain proximity, but also a pre-screening process that is as natural, spontaneous, and playful as the in-person socialization with strangers. The present invention provides a method and a system to fulfill this need.

### SUMMARY

In accordance with the embodiments described herein, a method and a system is disclosed for real-time random matching and compatibility assessment. This summary is not an extensive overview, and it is not intended to identify key/critical elements or delineate the scope thereof. Its sole purpose is to present some concepts in a simplified form as a prelude to more detailed description that is presented later.

The method of the invention provides means for individuals to indicate via mobile phones or another computer devices their availability for matching. The system algorithmically calculates virtual matching pools for each match request. The virtual matching pools are calculated based on the nearness of the other participants to the individual requesting matching. An individual is selected randomly from each virtual matching pool, and, then the system initiates a compatibility assessment session between the matched individuals. The system issues questions drawn from the database repository of questions with structured choice sets. Each individual selects an option from the choice set and submits the response asynchronously to the system. The system compares the responses, tabulates the results, and computes the cumulative score indicating the degree of matching.

The system is not limited to a static repository of questions. Individuals may extend the real-time compatibility assessment sessions by submitting new questions with structured choice sets. The system can facilitate continuous conversation via instructed question/answer sessions.

The present invention offers advantages and improvements over prior computer matching systems, as described in patents US2008/0052288, US2009/0112985, U.S. Pat. No. 6,272,467, US 2006/0059160, U.S. Pat. No. 7,203,674, U.S. Pat. No. 7,246,067, because it allows for serendipitous discovery of mutual compatibility in a virtual environment. The method of proximity matching in ad hoc generated virtual pools resembles closely the chance encounters with strangers that occur frequently in social settings. In the prior art, individuals browse profile repositories and deliberately choose potential partners based on the profile information. Other systems provide means to narrow down the choices by allowing users to filter down the repository based on particular profile attributes or by deploying statistical models to match each user's profile against a set of profiles in the repository. The present invention intentionally limits the engagement session to a sequence of structured questions with predefined choice sets, while the methods in the prior use free form text messaging, email, or live chat for communication between matched individuals. The present communication method is different from the prior art because the questionnaire process provides a game-like engagement for exploring each other's preferences. The questions are unknown to the matched individuals, randomly selected from a repository, and varied over time. This new method incorporates elements of chance, surprise, self-learning, and lack of pre-meditation in the communication process which facilitates the spontaneous discovery of each other's true preferences. By utilizing a game-like approach, the present method induces psychological comfort in the participants. Such comfort is lacking in the matching systems from the prior art because the browsing of online profiles and deliberate selection of potential partners invoke associations with online shopping. The notion of “shopping for a partner” suppresses the romantic expectations and inhibits the desire of individuals to reveal their true preferences and personal traits.

### BRIEF DESCRIPTION OF THE DRAWINGS

FIG. 1 is a high-level diagram of an embodiment of the system for providing an online real-time matching and compatibility assessment services;

FIG. 2A illustrates individual requests for real-time matching and compatibility assessment made to a system server device;

FIG. 2B illustrates the matching pools calculated for each matching request by the system server device of FIG. 2A;

FIG. 2C illustrates the random selection of the matching individual within each matching pool by the server device of FIG. 2A;

FIG. 2D illustrates the session for compatibility assessment between the matched individuals initiated by the server device of FIG. 2A;

FIG. 2E illustrates the resolution of overlapping virtual matching pools where members located at the intersection belong simultaneously to multiple pools;

FIG. 3 illustrates the real-time compatibility assessment session between two matched individuals within the entire pool of logged-in members;

FIG. 4 is a flow chart of the real-time mutual compatibility assessment session;

FIG. 5 is a flow chart of an embodiment of a process for binary choice questions and answers; and

FIG. 6 is a flow chart of an embodiment of a two-step process for determining the degree of matching in multiple choice questions.

### DETAILED DESCRIPTION OF THE INVENTION

Various embodiments of the present invention will be described in detail with the reference to the drawings, where like reference numerals represent like parts and assemblies throughout the several views. References to various embodiments do not limit the scope of the invention, which is limited only by the scope of the claims attached hereto. Additionally, any examples set forth in this specification are not intended to be limiting and merely set forth some of the many possible embodiments for the claimed invention. Among other things, the present invention may be embodied as methods or devices. Accordingly, the present invention may take the form of an entirely hardware embodiment, and entirely software embodiment, or an embodiment combining software and hardware aspects. The following detailed description is, therefore, not to be taken in a limiting sense.

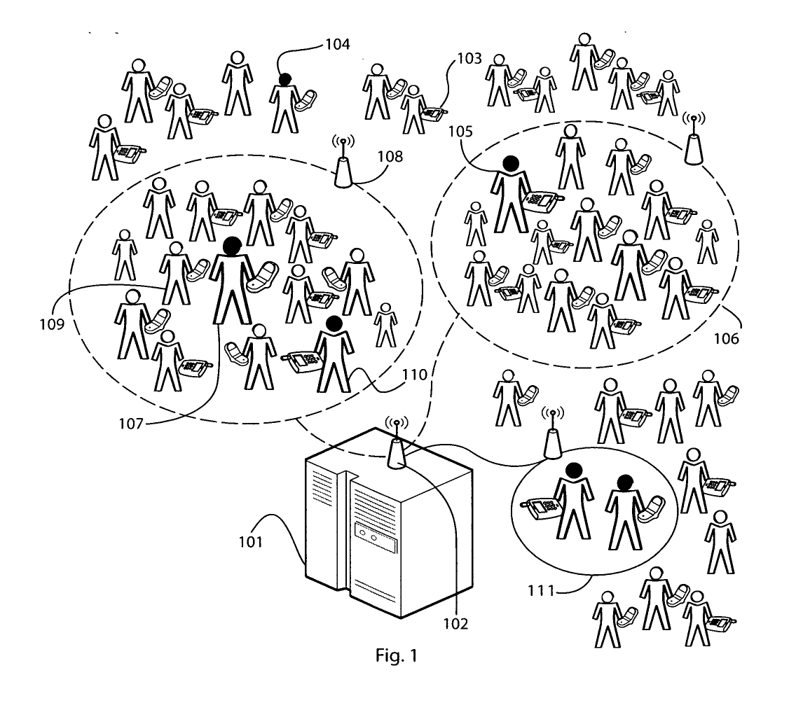

FIG. 1 is a high level diagram of an embodiment of the invention. For the purposes of explaining the invention, the invention will be described as it is embodied in a system used for providing real-time random matching and mutual compatibility assessment services. FIG. 1 shows the main server component 101, and its telecommunication module 102. The telecommunication module 102 establishes the connections and maintains all communications between member devices 103 and the server component 101. The server component 101 registers each individual member 104 as available for matching and collects their location information. Member 105 is registered with the server component 101 and the server component 101 has calculated a virtual proximity matching pool 106 for member 105 based on his location. The server component 101 is highly scalable and can compute simultaneously multiple virtual matching pools as shown by matching pools 106 and 108. Those skillful in the art will understand that virtual matching pools may be calculated by using other criteria or by supplementing the proximity algorithms with additional criteria. Virtual matching pool 108 is shown exactly at the moment of the execution of the matching by the server components 101, and immediately prior to its dissolution and initialization of a compatibility assessment session. Member 110 is randomly selected from all members in the virtual proximity pool 108 as a match for member 107 even though other members, as for example member 109, may be physically closer to member 107. After matching two members, the server component 101 initiates a real-time mutual compatibility assessment session 111. The server component 101 is highly scalable and can execute and maintain many mutual compatibility assessment sessions across dispersed geography.

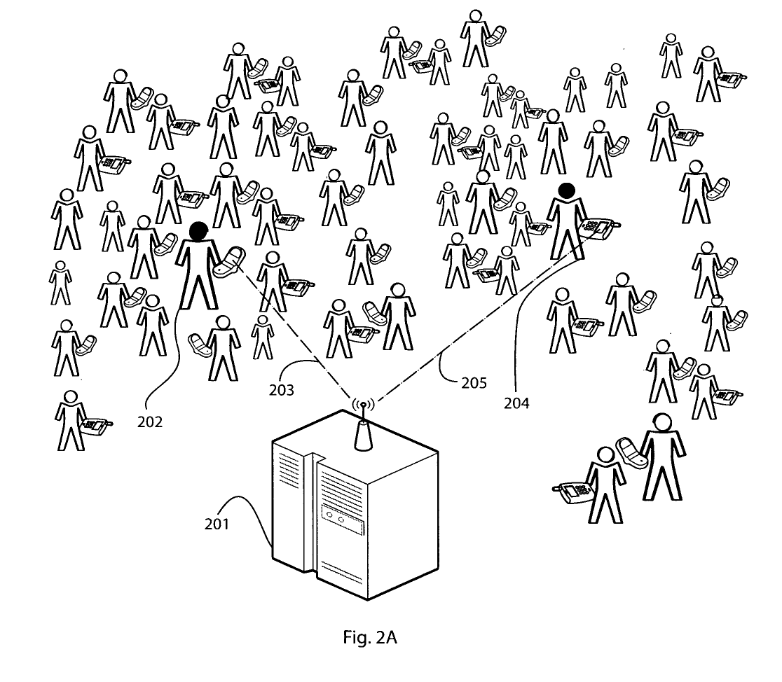

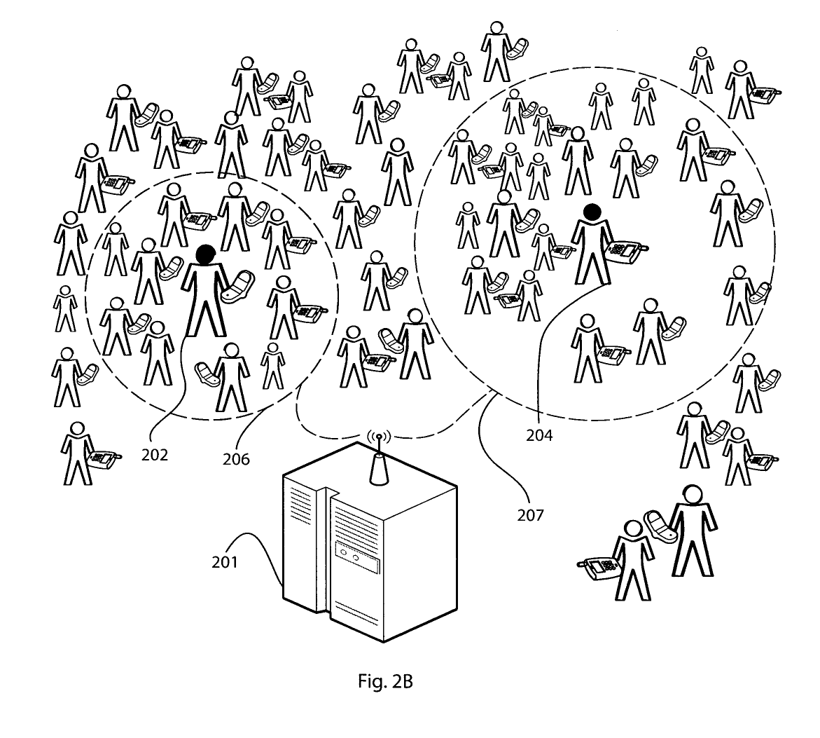

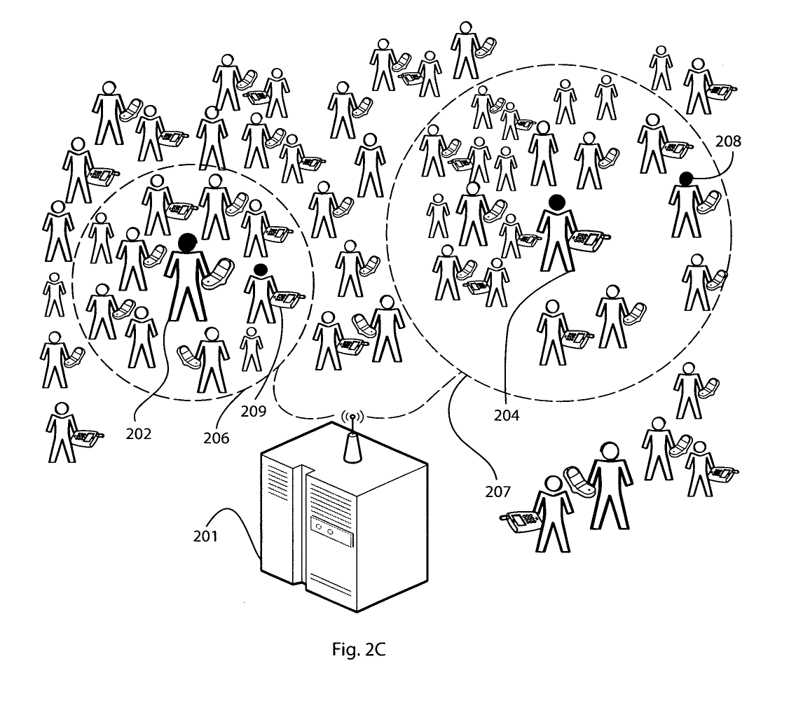

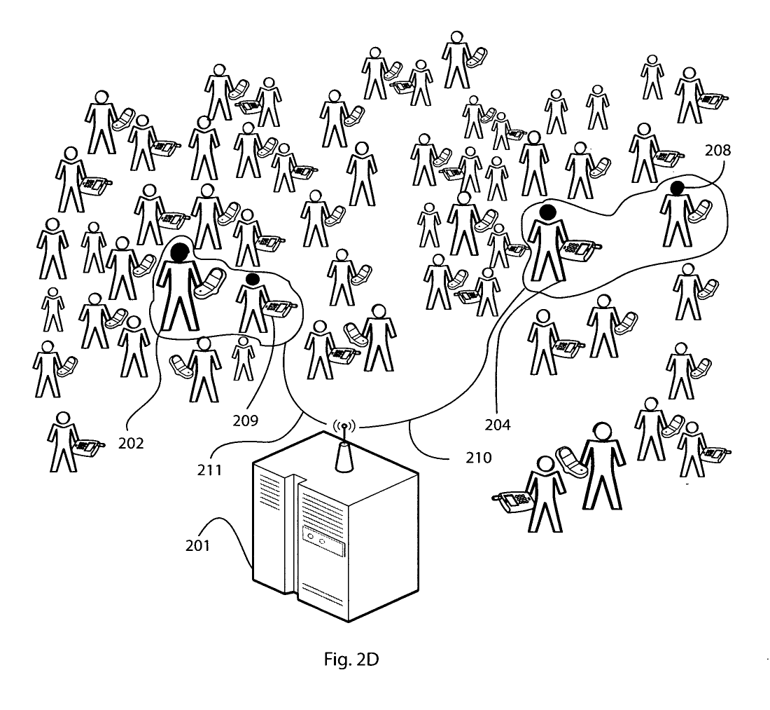

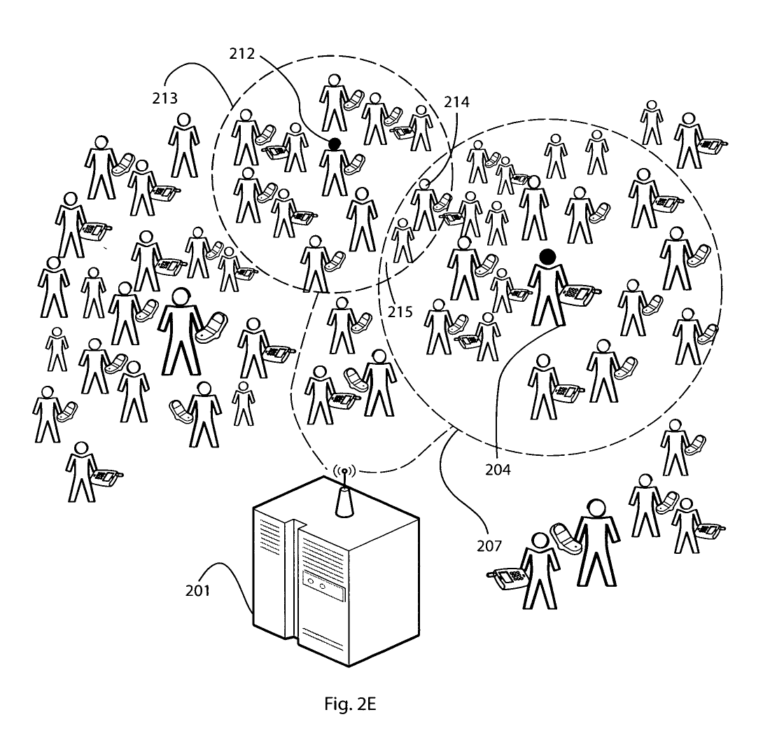

FIGS. 2A, 2B, 2C, and 2D are high level diagrams showing sequentially each step of the matching and mutual compatibility assessment process in one embodiment of the present invention.

FIG. 2A is a diagram of all members who have logged into the system server component 201. Although individual members may be logged in, the calculation of any virtual matching pool is executed only upon an explicit request by a logged-in member. Member 202 and member 204 have placed separate matching requests 203 and 205 to the server component 201. Logged in members who are not actively engaged in the matching process, may experience other forms of engagement with the system, such as viewing system statistics, exploring content, reviewing personal history, etc.

FIG. 2B shows a matching pool 206 calculated for member 202 by the server component 201 and a separate matching pool 207 calculated by the said server component 201 for another member 204. The proximity parameters of the individual matching pools may be different, and, therefore, matching pool 207 covers larger area than matching pool 206. The number of individual members in each virtual matching pool may vary too. The sizes of the individual virtual matching pools may be algorithmically adjusted based on minimum or maximum distance from the match requesting individual, or, alternatively, until a minimum or maximum number of members is reached within the calculated virtual matching pool. All parameters of the virtual matching pools may be specified on an individual member level, for the entire groups or categories of members, for specific geographies, or by any other criteria. For example, virtual pools for geographic areas with smaller density of members may have larger preset areas in order to guarantee sufficient number of potential matches. Those skillful in the art will immediately understand that any algorithm for computing virtual matching pools can be parameterized in a manner that allows various criteria to be adjusted for each individual, geography, or other aspect of the system.

FIG. 2C shows the method of executing matching requests by the server component 201. The server component 201 has matched member 202 with member 209 within matching pool 206, and member 204 with member 208 within matching pool 207. The server component 201 is highly scalable and can execute simultaneously and/or sequentially a large number of matching requests. The matching criteria can be refined for individual matching requests and also for groups or categories of requests. For example, prior matches, i.e., individuals who have been matched before, may be disqualified from being selected in the current matching request. Although the system does not reveal the identities of the matched individuals during the compatibility assessment session, the backend repository keeps detailed records of all individual interactions. The matching algorithm looks up the prior records and if the two individuals have been previously matched, it disqualifies the match and selects randomly another individual from the virtual matching pool. Another example is a refinement of the matching criteria for individuals who have same gender preference and thus require disqualifying other genders from being selected as matches. For those skillful in the art, it will be obvious that the disqualification criteria can be applied either during the computation of the virtual matching pool or during the execution of the match selection from the virtual matching pool.

FIG. 2D shows the method of execution of compatibility assessment sessions. After a match has been executed as shown in FIG. 2C, the server component 201 dissolves the virtual matching pool and places members 202 and 209 in a mutual compatibility assessment session 211, and members 204 and 208 in another mutual compatibility assessment session 210. The server component 201 is highly scalable and can maintain simultaneously a large number of mutually compatibility assessment sessions.

FIG. 2E shows one embodiment of the preferred invention where virtual pools 213 and 207, computed to satisfy the match requests of members 212 and 204 respectively, have an overlapping area. The physical location of member 214 is within the intersection 215 of the two virtual matching pools 213 and 207, and, thus, member 214 belongs to both virtual matching pools. With a large number of matching requests, intersections of two and more matching pools can occur. If member 214 is selected simultaneously as a match for both members 212 and 204, the server component 201 will resolve the matching conflict. Time precedence can be applied to resolve such conflicts in which case the member with the earlier matching request wins. The system collects a wide variety of timings that can be used to assign precedence to matching conflicts. Alternatively, the distance between two members can be used to resolve a matching conflict and assign the match to the nearest member. It will be obvious to those skillful in the art that there are other methods for resolving matching conflicts. If any of these methods fail to resolve the matching conflict, member 214 can be randomly assigned as a match to either member 212 or member 204. The server component 201 is highly scalable and can construct large number of overlapping pools and resolve matching conflicts efficiently.

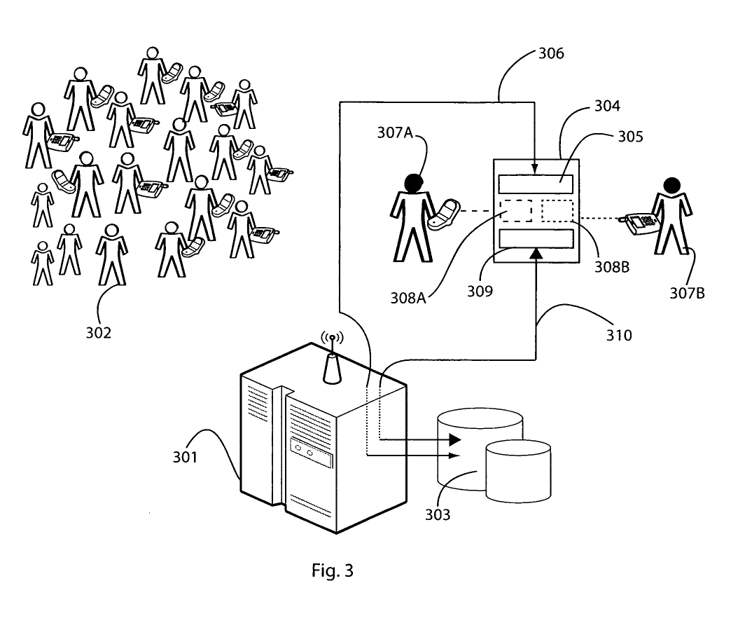

FIG. 3 shows one embodiment of the preferred invention where some members, as for example, member 302, are logged in the server component 301 but are not participating in compatibility assessment sessions, while members 307A and 307B are engaged in a compatibility assessment session maintained by the said server component 301. The mutual compatibility assessment interface 304 is accessible on both user 307A and 307B devices and is used by both members to provide input and get feedback from the said server component 301. When matched individuals are placed in a mutual compatibility assessment session, the server component 301 initiates a process 306 to retrieve choice questions from a repository 303 and to display them sequentially in the mutual compatibility assessment interface 304. Each question and its answer set 305 are displayed in the mutual compatibility assessment interface 304. Members 307A and 307B independently select and submit answers 308A and 308B for each question displayed in the mutual compatibility assessment interface 304. The server component 301 initiates a process 310 to collect all answers 308A and 308B in the said repository 303, to compute the degree of matching for each individual question and the cumulative matching score for all answers, and to transmit and display the compatibility score 309 in the mutual compatibility assessment interface 304. For those skillful in the art, it will be obvious that the mutually compatibility assessment interface 304 may have various page designs and layouts.

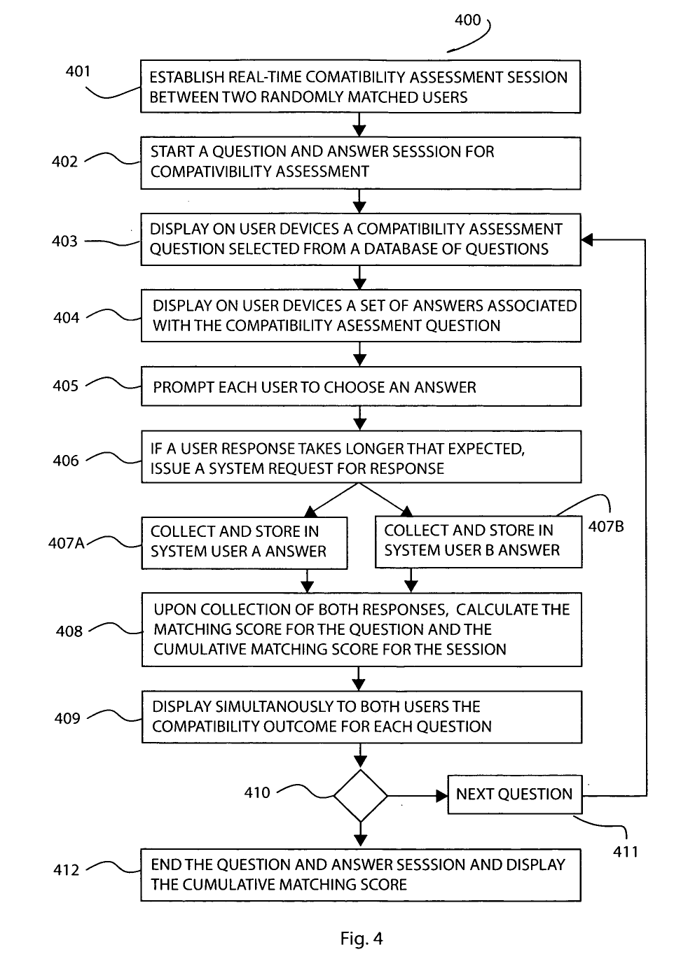

FIG. 4 is a flow chart of an embodiment of a method 400 for mutual compatibility assessment according to the present inventions. The method 400 begins at processing block 401 by establishing a real time electronic connection between two randomly matched individuals from a virtual matching pool. Method 400 then continues to block 402 to initiate a question and answer session. Recall from FIG. 3 that all questions are drawn from a repository and all responses are stored in the said repository. In block 402, unique identifiers are created for each compatibility assessment session. Those unique identifiers are also used to determine if two individuals have been previously matched as explained in FIG. 2C. Method 400 then continues to block 403 which picks and displays on the compatibility assessment interface the first question. Method 400 continues to block 404 to display on the compatibility assessment interface the choice set associated with the question from block 403. Block 405 provides an electronic technique for selecting one answer from the answer set in block 404. Block 406 issues a system request for an answer if a user takes longer than expected to make a selection in block 405. Blocks 407A and 407B process separately the responses of each individual engaged in the mutual compatibility assessment session. Next at block 408, the individual responses are processed and the degree of compatibility is calculated both for the current question and for the total number of answered questions. Block 409 displays the matching scores to the participants in the mutual compatibility assessment session. The process in block 409 can be optionally configured to display only the current question matching score, leaving the cumulative matching score to be displayed at the end of the entire session in block 412. Block 410 keeps count of the number of questions answered by the members and determines whether to process a new question via block 411 or to terminate the session at block 412. If the number of answered question is less than the minimum required by the method 400, block 410 triggers the process in block 411 which causes the method 400 to repeat steps 403 through 409. If the number of answered questions meets the requirements for the completion of the compatibility assessment session, block 410 triggers the process in block 412 which displays the cumulative matching score. There are many known methods to put the two individuals into a contact if they reach the required mutual compatibility score.

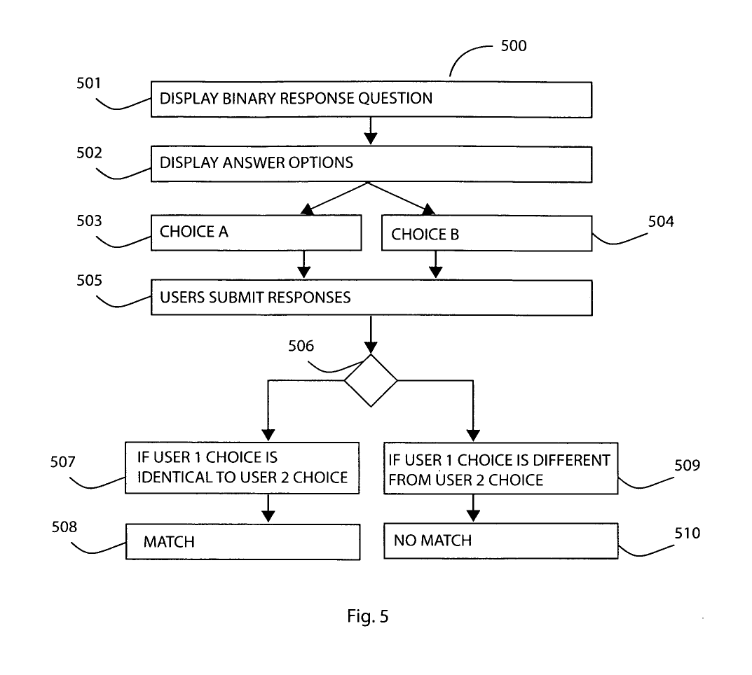

FIG. 5 is a flow chart of a method 500 for evaluating the degree of matching for binary choice questions. The method begins at block 501 with the display of a question. Recall from FIG. 3 that all questions are stored and drawn from the system repository. Next at block 502, the two mutually exclusive binary choice options are displayed. For the purpose of illustration, the two mutually exclusive binary choice options are labeled “Choice A” and “Choice B”. Block 503 provides means for the users to select “Choice A” and block 504 to select “Choice B”. Users can make only one selection—either “Choice A” or “Choice B”. Blocks 503 and 504 are interlinked, and, thus, making a new selection cancels any prior selection. The last selection is the active selection that is transmitted to the system repository. Block 505 submits each user response to the system repository described in FIG. 3. Next at block 506, a logical comparison process is initiated. Block 507 evaluates if the two responses are identical, and if they are, it passes the information to block 508 to record a match and calculate the matching score. Block 509 evaluates if the two responses are different, and if they are, it passes the information to block 510 to record the lack of match and the matching score. For binary questions, the matching score is the ratio of the matched responses to the total responses. In other words, the matching score is computed based, at least in part, on the probability of having identical user choices. Those skillful in the art will understand that various weights can be applied to different questions in order to make the cumulative matching score more precise. Weights allow incorporating additional criteria in the evaluation process. For example, questions about food preferences may be weighted less than questions about book preferences. Thus, matched responses to food related questions will contribute less to the cumulative matching score than matched responses on book related questions.

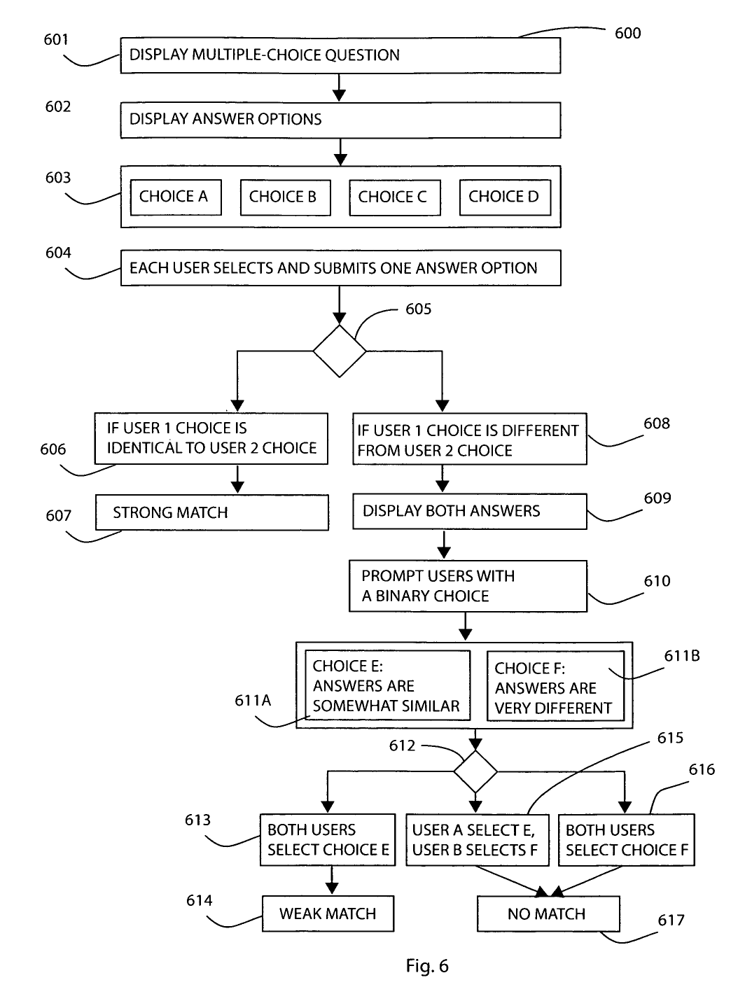

FIG. 6 is a flow chart of a method 600 for evaluating the degree of matching for multiple choice questions. Multiple choice questions pose a specific problem as the probability of an exact match is a function of the number of possible choices, and, thus, it is much smaller than the probability of a match in binary choice questions. It becomes highly likely that the majority of users will select different responses. Yet, if the respondents are allowed to examine their different choices, they may consider some choices to be “somewhat similar” and other choices to be “very different”. For example, if the multiple choice question is about ice cream flavor preferences, one user may like “chocolate” flavor and the other “raspberry” flavor. If asked whether they consider their stated preferences to be similar, they are likely to respond that the two flavors are very different. But if they have chosen “banana” and “strawberry” flavors instead, they might consider the fruit flavors to be somewhat similar. The method 600 allows for capturing such subtleties in the responses and to incorporate them in the matching score. The method 600 begins at block 601 with the display of a question. Next block 602 presents the multiple choice answers. Block 603 provides means for the users to select and submit responses. For illustration purposes, the selectable choice options are labeled “Choice A”, “Choice B”, “Choice C”, and “Choice D”. Any number of selectable choice options can be presented to the users. Block 604 processes each user's selection. Block 605 uses logical algorithms to evaluate the responses and to determine the degree of matching. If it is determined in block 606 that the two user choices are identical, block 607 processes the overall question score as a strong match. Strong matches are given higher weight in the calculation of the cumulative matching score. If it is determined in block 608 that the two responses are different, block 609 displays to both users their responses and block 610 prompts them with a binary choice. Two mutually exclusive binary selectable options are displayed in blocks 611A and 611B. The selectable option in block 611A, labeled as “Choice E”, allows the participants in the mutual compatibility assessment session to indicate that their prior choices seem somewhat similar to them. The selectable option in block 611B, labeled as “Choice F”, allows the participants in the mutual compatibility assessment session to indicate that their choices appear very dissimilar to them. Block 612 applies a logical algorithm to evaluate the responses for the degree of matching. Block 613 determines if both users have selected the option in block 611A, and passes the information to block 614 to process as weak matching score. Weak matches are given lower weight in the calculation of the cumulative matching score. Block 615 determines if both users have selected different options, e.g., one user has selected the option in block 611A and the other the option in block 611B, and passes the information to block 617 to process no-matching score. Block 616 determines if both users have selected option 611B, and passes the information to block 617 to process no-matching score. Those skillful in the art will understand the step to reduce multiple choices to binary choices can be implemented in any number of steps to capture at a finer level of granularity the degree of matching. The matching score for multi-step questions can also be computed based, at least in part, on the unconditional or conditional probability of having identical user choices at each step in the process. The choice reduction process allows for creating a continuous matching score that represents more accurately the degree of matching.

What is claimed is:

1) Computer based real-time random matching and mutual compatibility assessment method comprising:
Computing ad hoc virtual matching pools of individuals based, at least in part, on their location and proximity to a person requesting a match;
Randomly matching the person requesting a match with a member of the computed ad hoc virtual matching pool;
Engaging matched individuals in a virtual real-time mutual compatibility assessment session;
Presenting the matched individuals with a set of questions with structured choices sets drawn randomly from a repository of questions;
Computing a mutual compatibility score based on the degree of similarity of the selected responses from the structured choice sets;
Revealing to the matched individuals the mutual compatibility score.

2) The method of claim 1 further comprising the step of qualifying individuals for inclusion in the ad hoc virtual matching pools based on predefined criteria.

3) The method of claim 1 further comprising of the step of assigning members that belong simultaneously to multiple ad hoc virtual matching pools to only one virtual real-time mutual compatibility assessment session.

4) The method of claim 1 further comprising the steps of evaluating the congruence of responses to a binary choice question and calculating a corresponding matching score.

5) The method of claim 1 further comprising the steps of evaluating the congruence of responses to a multiple choice question, presenting a second clarifying binary choice question if the responses to the multiple choice question are not identical, evaluating the responses to the said second clarifying binary choice question, and calculating a weighted matching score based on the overall degree of congruence in all responses.

6) The method of claim 1 further comprising of computing a matching score based, at least in part, on the probability of individuals selecting identical responses from the structured choice sets.

7) The method of claim 1 further comprising of the step of matched individuals submitting to one another user defined questions with structured choice sets.

8) Computer based real-time random matching and mutual compatibility assessment system comprising:
a function to compute ad hoc virtual matching pools of individuals based, at least in part, on their location and proximity to a person requesting a match;
a function to match the person requesting the match with a randomly selected member of the computed ad hoc virtual matching pool;
a function to engage matched individuals in a virtual real-time mutual compatibility assessment session;
a function to present the matched individuals with a set of questions with structured choices sets drawn randomly from a repository of questions;
a function to compute a mutual compatibility score based on the degree of similarity of the selected responses from the structured choice sets;
a function to reveal to the matched individuals the mutual compatibility score.

9) The system of claim 8 further comprising:
a function to qualify individuals for inclusion in the ad hoc virtual matching pools based on predefined criteria.

10) The system of claim 8 further comprising:
a function to assign members that belong simultaneously to multiple ad hoc virtual matching pools to only one virtual real-time mutual compatibility assessment session.

11) The system of claim 8 further comprising:
a function to evaluate the congruence of responses to a binary choice question and to calculate a corresponding matching score.

12) The system of claim 8 further comprising:
a function to evaluate the congruence of responses to a multiple choice question, to present a second clarifying binary choice question if the responses to the said multiple choice question are not identical, to evaluate the responses to the said second clarifying binary choice question, and to calculate a weighted matching score based on the overall degree of congruence in all responses.

13) The system of claim 8 further comprising:
a function to compute a matching score based, at least in part, on the probability of individuals selecting identical responses from the structured choice sets.

14) The system of claim 8 further comprising:
A function for matched individuals to submit to one another user defined questions with structured choice sets.
